(19) United States
(12) Patent Application Publication
(10) Pub. No.: US 2025/0383440 A1
(43) Pub. Date: Dec. 18, 2025

(54) SURVEILLANCE SYSTEM FOR THE OPTIMAL CALCULATION OF THE REAL-TIME SIMULTANEOUS LOCATIONS OF MULTIPLE TARGETS

(71) Applicant: Timothy Grant Hall, Miami Beach, FL (US)

(72) Inventor: Timothy Grant Hall, Miami Beach, FL (US)

(21) Appl. No.: 18/744,870

(22) Filed: Jun. 17, 2024

(51) Int. Cl. G01S 13/78

(52) U.S. Cl. CPC G01S 13/78

(57) ABSTRACT

A surveillance system for the optimal calculation of the real-time simultaneous locations of multiple targets. The surveillance system uses the known locations in a given 2- or 3-dimensional frame of reference of possibly moving in a known path or statically located detection units for the simultaneous calculation in real-time of the locations of multiple targets that are either transmitting a coded identification signal at regular time intervals or are detected through the return of energy of unidentified targets. The calculated position for each target includes a point in the frame of reference most likely to be the actual position of the target based on the expected variability of the coded identification signals, along with a probability map, such as a 2-dimensional ellipse or 3-dimensional ellipsoid, separately for each target, presenting the likelihood of the actual position of the target being within a particular region of the frame of reference.

### BACKGROUND OF THE INVENTION

The present invention relates to surveillance systems and, more particularly, to a surveillance system for the optimal calculation of the real-time simultaneous locations of multiple targets.

Generally, current surveillance systems utilize one of the underlying techniques to surveil their targets: multilateration, mobile radar systems, primary/secondary ground-based radar systems, and they must all address sensor quality issues such as the probability of signal detection, Friendly Replies Uncoordinated in Time (FRUIT), multipath signal corruption, and expected regions of significant error.

The concept of utilizing an array of sensors to calculate a position report is well represented in the prior art. Patents as far back as Koeppel, U.S. Pat. No. 2,855,595, October 1958, have utilized “a plurality of reference points” (this expression is used in Heldwein, et al., U.S. Pat. No. 4,229,737, October 1980) as a basis for determining a target's position. Additional references to arrays of sensors and reference points for locating a “vehicle” or “transceiver” include Drouilhet, et al., U.S. Pat. No. 5,570,095, October 1996; Nilsson, U.S. Pat. No. 4,524,931, June 1985; Chisholm, U.S. Pat. No. 3,412,399, November 1968, and Fletcher, et al., U.S. Pat. No. 3,153,232, October 1964. In fact, Jandrell, U.S. Pat. No. 5,526,357, June 1996, as a continuation of U.S. Pat. No. 5,365,516, August 1991, extends the use of the sensor array to a “two-way message delivery system for mobile resource management,” including the use of “a control center containing means for determining the location of the polled transponder.” In a related track, a “method and system for highly accurate navigation of . . . ships and aircraft” using “transmitted wave energy at regular intervals” was described in Beasley, U.S. Pat. No. 4,024,383, May 1977. In addition, the use of “multilateration,” (a technique for determining the position of an unknown point of a target based on measurement of the times of arrival of energy waves traveling between the unknown point and multiple stations at known locations)—i.e., the use of multiple sensors to calculate positions from transmitted signals, is used in Jandrell (cited above), Saito, et al., U.S. Pat. No. 4,673,921, June 1987; Fuller, et al., U.S. Pat. No. 3,646,580, February 1972; and as far back as Ross, U.S. Pat. No. 2,972,742, February 1961.

A recent development found in Smith, et al., U.S. Pat. No. 6,094,169, July 2000, includes a “correction method” for multilateration “based on a signal from secondary radar.” Furthermore, modern, widely used systems such as GPS (Global Positioning Satellites), LORAN (Long-range Radio Navigation), and Lo-Jack® use differential arrival times at “a plurality of reference points” to produce their position reports, with claims of “excellent” accuracy given proximity constraints.

However, none of these existing patents, with the information found collectively in the prior art, adequately addresses five practical, critical issues that are completely solved by the present invention. The prior art either completely ignores these issues, such as in the cited pre-1980 patents, or only briefly touches on the issues without providing objective, justifying documentation. The six critical issues left unsatisfied in the prior art may be called the Issues of Distinction, Likelihood of Accuracy, Maintenance, Universality, Redundant Distributed Processing, and Optimality.

The pertinent prior art that utilizes an array of sensors to calculate a position report always refers to a context specific to the patent. Beasley, U.S. Pat. No. 4,024,383, May 1977, refers to “ships and aircraft,” while Jandrell, U.S. Pat. No. 5,526,357, June 1996, specifically mentions “mobile resource management” with respect to where equipment is located at a given moment. And Drouilhet, et al., U.S. Pat. No. 5,570,095, October 1996, refers to “vehicles,” meaning equipment that physically resembles an automobile or cart. Since there is always a particular context in which the patent is described, the prior art fails to address the Issue of Universality, where the methods and system in question work equally well regardless of embodiment context.

Another gap in the prior art that is inherent in the design of surveillance systems is the Issue of Redundant Distributed Processing. There is a single-point of failure in any surveillance system that processes data (input) to produce a value-added product (output) if all processing takes place in a single subsystem—especially a dedicated subsystem operating exclusively in a single calculation environment. If such a processing subsystem were to fail (either deliberately or otherwise), or be corrupted, or worse yet, operationally produce useless/deceptive results, it does not matter how well the input data are collected, with as much accuracy and precision as possible if that data were processed incorrectly.

All data transmissions, from whatever source or through whichever medium, are subject to error, whether through corrupted transmission, fraudulent use, or aberrant conditions. When information is received at a sensor, data corruption in some sense is always possible, as well as abhorrent signals from reflections, or even from intentional false data inserted to deceive the sensing equipment. The extent and efficiency with which a method or system addresses the potential presence of corrupted data determines how useful that method or system may be. This is the Issue of Likelihood of Accuracy, i.e., how likely are the position reports accurate and to what extent can it detect “false” or “impossible” or even “unlikely” data? Can the method or system consistently produce a position report within a given distance, say, 95% of the time over, say, a 24-hour period using only “valid” data? This issue is touched upon in Smith, et al., U.S. Pat. No. 6,094,169, July 2000, without quantification, by use of a secondary radar system, which may or may not be applicable outside of aviation uses, and which may or may not be as accurate as the original position report due to registration uncertainty. Furthermore, Beasley, U.S. Pat. No. 4,024,383, May 1977, claims to produce a “highly accurate” report, again without justification nor quantification. The prior art otherwise contains very little objective quantification concerning the Issue of Likelihood of Accuracy, if it is addressed at all. Without quantifying and controlling the likelihood of an inaccurate position report in a meaningful and automatic manner, the method or system under consideration cannot be trusted to produce useful information.

All electrical and mechanical equipment, such as the “array of sensors” or “plurality of reference points” mentioned in the prior art, is subject to malfunction, sometimes manifested as catastrophic failure, but more often as a slow, cumulative wearing out of control. The ability of a method or system to sense when a sensor, or group of sensors, has reached a point where its cumulative wear is now producing significantly erroneous data, is critical to the usefulness of such a method or system. If one cannot tell when the system is reporting garbage, how can its output be trusted? This is the Issue of Maintenance. The prior art is silent on the integration of concurrent maintenance of a target reporting system. No mention is made in the prior art concerning a method or system that can sense during its operation when a sensor has significantly worn out of control.

In sum, when trying to simultaneously determine the position of friend targets (those trying to be detected) and foe targets (those trying not to be detected) in a common theater of operations, the myriad presence of lack of accurate signal detection, the confusion of multi-path signal routes, and the fixed positions of the sensors, etc., often prevent the calculation of any target position of value due to the unquantified uncertainty introduced by these factors in addition to other uncertainty already present in the system.

Current surveillance systems are restricted to (a) fixed sensor positions, (b) centralized processing capabilities, (c) inflexible choices for sources of data, and (d) point-estimates of position.

No current position-assessment system can produce real-time position reports of an unlimited number of friend/foe targets using fixed/mobile sensors with the level of certainty and accuracy as the present invention. As a result, other systems cannot be trusted to produce friend/foe position reports with the same level of accuracy, nor do they assess and filter “impossible” scenarios before producing contradictory or meaningless results.

As can be seen, there is a need for a surveillance system for the optimal calculation of the real-time simultaneous locations of multiple targets, wherein each of the previously mentioned weakness/inability/disadvantage in the prior art is addressed by the surveillance system embodied in the present invention, including the addition of an error likelihood assessment along with each position report.

### SUMMARY OF THE INVENTION

The disclosure addresses and solves the inherent uncertainty introduced by multilateration detection of friend/foe targets by introducing (a) redundant distributed computing capabilities, (b) moving sensor functionality, (c) uncertainty quantification based on best-choice sensor behavior, and (d) analytical optimization and mitigation steps during real-time position calculations.

The disclosure embodies a surveillance system for using the known locations in a given frame of reference of moving detection units for the simultaneous calculation in real-time of the locations of multiple targets that are either transmitting a coded identification signal or are sensed by the return of energy from an isotropic radar pulse. The calculated position for each target includes a point in the frame of reference most likely to be the actual position of the target (based on the expected variability of the coded identification signals or the characteristics of the isotropic radar), along with a probability map, separately for each target, presenting the likelihood of the actual position of the target being within a particular contiguous region of the frame of reference.

Moreover, the surveillance system embodied in the present invention employs error-bounding methods that work equally well when the sensors are microscopic entities in an animal's bloodstream, or detecting aircraft at great distances, or in tracing vortex changes in a tornado. Furthermore, the surveillance system of the present invention allows for the sensors to be moving (in time) in their frame of reference, or be statically located, all in either a 2- or 3-dimension context—functionality completely lacking in the prior art, nor even mentioned as a possibility. The present invention is context neutral, or context independent.

The present invention can distinguish between targets that are trying to identify themselves—cooperative targets known as friend targets—and those targets that are actively trying to avoid identification, both to number and position—uncooperative targets known as foe targets—or a mixture within the theater of (known) friend and foe targets. This is the Issue of Distinction. There is nothing in the prior art that would enable a single surveillance system to simultaneously track a mixture of friend and foe targets within a single theater of operations through any number of (possibly moving) sensors in either a 2- or 3-dimensional frame of reference.

The present invention contains non-obvious, novel, and critically useful analytical algorithms and data structures that quantify the Likelihood of Accuracy of each position report individually at the time of calculation, and collectively as further processing continues. Furthermore, data that has been corrupted or intentionally altered is sensed automatically by analytical methods, thus preventing this data from corrupting the position report. This important feature of the disclosure ensures that any given position report may be trusted, in the sense that the probability that it represents a significantly incorrect report may be made arbitrarily small by adjusting the calculation parameters in the analytical methods.

The present invention contains analytical methods, data structures, and an operational policy for discerning during its operation when a sensor has significantly worn out of control, has entered an inoperable state, or has failed outright. Each position report is evaluated for consistency and likelihood of applicability to detect when sensors may be wearing out of control, or when “impossible” data has been received. This ongoing surveillance of the data quality involved in the calculations is automatically applied to the reporting subsystem without the need for outside, primary, i.e., human-based monitoring. This vitally useful and novel feature disclosed herein is not addressed in the prior art.

The present invention definitively prevents any possibility of such a single point of failure by distributing the complete processing functionality of the system into every sensor. Whenever a sensor detects information, either from a self-identifying friend target or from the return of energy from a foe target, that information is securely sent to all other theater sensors for further processing (where each sensor produces position information independently of all other sensors, and subsequently securely communicates those results to all other theater sensors). Since all sensors produce the same results from the same input data, regardless of the number of friend, foe, or mixed targets, simply taking down any number of sensors will not degrade the production of position information from the remaining sensors. In this respect, the present invention has redundant and distributed processing protections as a fundamental aspect of its design and embodiment.

The present invention addresses the Issue of Optimality by defining objective, analytical methods for optimizing the performance of the present invention before any data is collected, or before any calibration is needed. This distinguishes the disclosure from the prior art by minimizing the natural introduction of error into position calculations through numerical optimization algorithms. The prior art makes no attempt to optimize its performance from a priori information. For example, Smith, et al., U.S. Pat. No. 6,094,169, July 2000, refers to an “error correction” through a signal from a secondary radar interrogation (with clear context to a ground-based radar system most used in aviation surveillance). However, the extent to which the “error” is “corrected” due to characteristics of the secondary radar system is not addressed, nor even mentioned in the preferred embodiment. In other words, is the error correction due to Radar System #1 better than that from the use of Radar System #2, and if so, by how much, and why?

In one aspect of the present invention, a system for simultaneously determining the locations of a plurality of targets in a 2- or 3-dimensional frame of reference (3DFOR), the system provides a plurality of theater detection units, each configured to send/receive a set of timing data to/from each other, wherein each theater detection unit has a central processing unit configured to (a) transmit and receive electromagnetic energy to/from each target of the plurality of targets, (b) generate a target position report (TDR) when the set of timing data is sent to the central processing unit within each theater detection unit, wherein the target position report defines a location for each target of the plurality of targets as a foe target or a friend target based on the type of signal detection of each target, and (c) generate an elliptical/ellipsoidal probability map for each said location; and the central processing unit within each theater detection unit is configured to determine a level of accuracy for each target position report based on a comparison of its location against the location of the elliptical probability map, whereby the central processing unit optimizes each subsequent target position report based on the level of accuracy of a previous target position report of that central processing unit, wherein each central processing unit is identical regarding generation of the target report and the elliptical/ellipsoidal probability map.

In another aspect of the present invention, a system for simultaneously determining the locations of a plurality of targets in a 2- or 3-dimensional frame of reference wherein each TPR defines each target of the plurality of targets as a foe target or a friend target based on signal detection of each target, wherein the arrival time of each target is based on an absolute timing schedule, wherein the absolute timing schedule is defined by a Network Time Protocol synchronization, wherein said location is a position along the 3DFOR, wherein a transformed target position report (TTPR) comprises positions along the TDR wherein each position is subject to a distance-preserving isomorphic transformation, wherein each TDU moves within the 3DFOR along a known path, and wherein the known path is known only to the associated TDU.

These and other features, aspects and advantages of the present invention will become better understood with reference to the following drawings, description, and claims.

### BRIEF DESCRIPTION OF THE DRAWINGS

FIG. 1 is a schematic diagram of an exemplary embodiment of the present invention that depicts the data processing interaction between the principal central processing units and the related databases stored within each Theater Detection Unit (TDU—commonly referred to as “a sensor”), to produce the various stages of target position reports. All information within a TDU is shared through encrypted communications with all other TDU's in the common frame of reference. These interactions facilitate the production of the final form of the Target Position Report.

FIG. 2 is a functional view of an exemplary embodiment of the present invention, illustrating a TDU PCPU signal timing diagram 20, and specifically depicting the cyclic nature of the Principal Central Processing Unit (PCPU) signal timing that is coordinated to be identical within all TDU's. The Issue of Optimization is addressed (in part) in each processing cycle, e.g., mitigations for reflections are addressed during the Confirm period, whereas possibly corrupted data is addressed during the Query period.

FIG. 3 is a block diagram of an exemplary embodiment of the present invention in the context of a large-scale implementation 30.

FIG. 4 is a block diagram of an exemplary embodiment of the present invention, illustrating medium-scale use of an assembly factory implementation 40.

FIG. 5 is a schematic diagram of an exemplary embodiment of the present invention, illustrating a small-scale example use of an adaptive impurity filtering process 50.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a surveillance system for using the known locations in a given 2- or 3-dimensional frame of reference of possibly moving (in a known path) or statically located detection units for the simultaneous calculation in real-time of the locations of multiple targets that are either (a) Friend Targets—transmitting a coded identification signal at regular time intervals on specified yet varying frequencies, or (b) Foe Targets—targets identified by the return of energy from an isotropic radar pulse on specified yet varying times and frequencies, or (c) Mixed Targets—where non-zero-many friend and non-zero-many foe targets are known to exist in the same frame of reference. The calculated position for each target includes a point in the frame of reference most likely to be the actual position of the target (based on either the expected variability of the coded identification signals or characteristics of the probability distribution of the detection of the return of energy from the particular isotropic radar pulse used to detect the foe target), along with a probability map (a 2-dimensional ellipse or 3-dimensional ellipsoid), separately for each target, presenting the likelihood of the actual position of the target being within a particular contiguous region of the frame of reference.

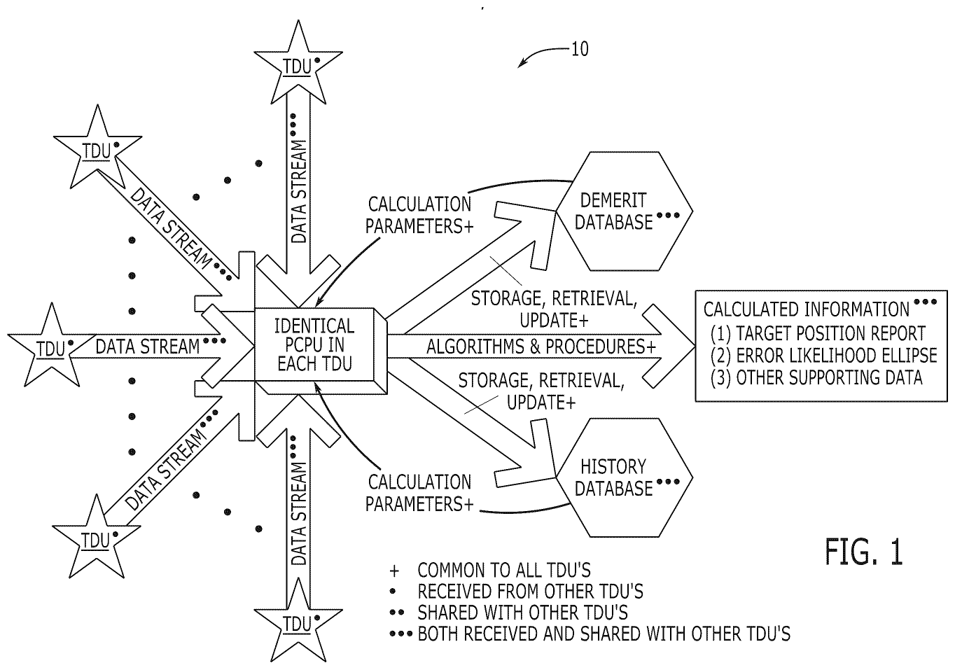

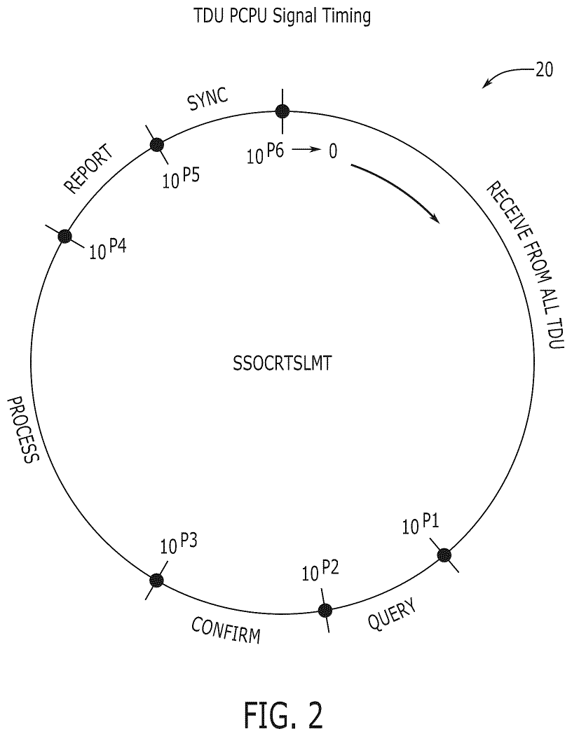

Referring to the Figures, an embodiment of the present invention provides a surveillance system 10 for the optimal calculation of the real-time simultaneous locations of multiple targets. The surveillance system 10 may embody the following components: mobile target detection sensors; a principal ASIC CPU (FIG. 1); supporting databases; network time protocol synchronization (FIG. 2); command, control, communications functionality; position report algorithm; error likelihood ellipse/ellipsoid algorithm.

Referring to FIG. 1, the surveillance system 10 includes a set of (at least four) full movement-capable—i.e., moving in 3-dimensions with 6-degrees of freedom, with 4-degrees of freedom in 2-dimensions, within a static frame of reference—Theater Detection Units (TDU) that assemble and securely communicate to all other TDU's in the frame of reference, through an encrypted Table of Contents and Payload protocol, all information necessary for each TDU to independently calculate a position report for each (known) target in the frame of reference using identical analytical methods, namely:
(a) identification information for the reporting TDU;
(b) arrival time of each (friend or foe) target signal (or return of energy) relative to the latest Network Time Protocol synchronization during the Sync time phase;
(c) position of the TDU at the time of signal or energy return receipt (relative to the frame of reference coordinates)—collectively called the Situational Awareness of the present invention; and
(d) the planned future movement path of each TDU at the time of signal or energy return at that TDU—which need be updated only if an Event Trigger occurs.

Each TDU may include the following:
(i) one Principal Application Specific Integrated Circuit (ASIC) Central Processing Unit (CPU), generically referred to as the PCPU;
(ii) a Network Time Protocol (NTP) daemon running within the PCPU that coordinates (and defines) the frame-of-reference-local-time absolute synchronization;
(iii) storage for all required algorithms and procedures to complete all analytical calculations within the Process time phase, including event triggers that modify the movement path of one or more TDU—which is void for non-moving TDU's—and Distinction Criteria, which provides the analytical criteria for distinguishing a return of energy from a foe target that might be confused with a close-by friend target;
(iv) a History Database for storing and utilizing most-recent prior calculation results (from all TDU sources);
(v) a Demerit Database for storing and utilizing prior assessed deficiencies in calculated results from all TDU sources—the purpose of which is to help determine which TDU's (if any) are producing the more reliable calculation results, which are thereby the most-likely-to-be-correct sources for position reports and error likelihood ellipsoids;
(vi) an isotropic radar transmitter, waveform generator, duplexer, isotropic receiver, and independent control systems for each component, in which the transmit/receive pulsed power and sensitivity (threshold of detection) requirements will depend on the size (and shape) of the desired frame of reference for theater operations; this equipment is standardized across all TDU's. The use of the transmitter to detect foe targets occurs an irregular number of times during the Receive From All TDU time phase at random times and at variable frequencies to prevent anticipation and avoidance by foe targets; this also allows for the opportunity to minimize the volume/area of the Error Likelihood Ellipsoid/Ellipse which addresses the Issue of Optimization;
(vii) a locally stored memory of statically stored data that each PCPU accesses for parameter data, algorithm exceptions, event triggers, distinction criteria, and other information, which are used to produce the following:
A. Target Position Report (TPR) individually for each Distinct Target, where targets with a signal detection are automatically considered a friend target, even if there is also a closely associated return of energy (which is not considered distinct from the friend target), and where targets with only a return of energy are automatically considered a foe target; and an
B. Error Likelihood Ellipsoid/Ellipse (ELE) individually for each distinct target; as well as
C. Supporting reports as the embodiment determines (see FIG. 1).
(viii) the PCPU in each TDU is identical across all TDU's with respect to access to supporting data, encrypted communication capabilities to the other TDU, processor speed, memory, and every other way in which the capabilities of microprocessors are measured.

Note that while four TDU are required for the analytical methods embodied in the present invention (in 3-dimensions—three are required in 2-dimensions), there must be more than four TDU to ensure all implemented functionality has the data needed to make the required calculations. For example, while four TDU produce only one position report per target, five TDU allow for five independently calculated position reports per target (choose 4 TDU among 5—in particular, choose the four TDU producing the most reliable data [an optimization technique available through the history and demerit databases stored in each TDU]), and six TDU allow for fifteen (15) independently calculated position reports per target (choose 4 TDU among 6), and so forth. The additional TPR's provided by more than four TDU are used to quantify the expected variation among the coded identification signals for both friend and foe targets. This quantification in turn is used to optimize the precision and accuracy of the TPR and ELE.

The PCPU, TDU's, and any database systems must be coordinated on, and agree with, an absolutely maintained time cycle, accurate to at least twice the precision of the anticipated Target Position Report.

A Target Position Report (TPR) is generated whenever the TDU's send a set of timing information to the PCPU. Since uncoordinated TDU operation might send information from TDU #1 to TDU #2 at the same time as TDU #3 does, or multiple TDU's might send supporting information about a target at the same time to another TDU, an absolute timing schedule (provided by the NTP) must be used to ensure valid comparison of timing and support data within the TDU set.

A Friend Target T may only initiate a signal to the TDU's at time t when t mod ξ=0, where ξ=10ⁿ/ρ cycles in a 10ⁿ-Hz PCPU, i.e., there are p signals per second. For example, if a friend target sends a signal to a TDU every half second, then ρ=2, and ξ=10ⁿ/2=10ⁿ/10^{log 10\hat{ }2}=10^{n-log 10\hat{ }2}.

Note that the larger n becomes, the more cycles the PCPU must process its friend target information.

The Effective Time of the present invention is the maximum time for this receive/query/confirm period. It measures the farthest a friend target may be away from the closest qualifying set of TDU's, i.e., detectable by a (programmable) minimum number of TDU's, and still be used by the calculation algorithms to produce n their required outputs. A complete Signal Period, i.e., ξ=10ⁿ/ρ cycles in a 10n Hz PCPU, includes six Time Phases, each encompassing an interaction between the PCPU's, the TDU set, and the parameter databases (see FIG. 2—where the pk integers, for 1≤k≤6 represent the partitioning of a 10ⁿ MHz processors duty to the

The Time Phases are, referring to FIG. 2:
1. Receive From All TDU, during which the PCPU's receive the detected signal information from the TDU's. This phase must last as long as the effective range, plus overhead time for encrypted communications between the TDU's. The information passed during this phase include: time phases).
(a) TDU ID;
(b) Friend/Foe Target ID;
(c) Time Of Signal Detection (of the friend target) or Return of Energy (of the foe target) at the TDU;
(d) Position of the TDU at the time of the signal detection or return of energy; and
(e) Planned future TDU movement path (if any) at the time of the signal detection or return of energy.

The TDU ID and Friend Target ID are static codes used throughout all phases and signal periods. If either the TDU ID or the Friend Target ID changes during a signal period, it must be through a formal change management process incorporated into the embodiment of the present invention. The Time of Signal Detection is relative to the common absolute timing mechanisms in the surveillance system 10.
2. Query, during which the PCPU's query each other for confirmation codes to ensure encrypted communication integrity. If the return confirmation code sent from one TDU to another is not correct (see the next phase), that PCPU queries the errant TDU again for the proper confirmation code. This is repeated up to a programmable number of iterations. If no correct confirmation code is received in the allotted time from a particular TDU, then that TDU's data are not considered further in calculating the TPR for the current processing cycle.
3. Confirm, during which a PCPU receives and processes the confirmation code sent by the other TDU's. It is during this phase that any required re-transmissions are also requested, received, and processed.
4. Process, during which all calculations are completed to produce the TPR and ELE for all friend and foe targets, and subsequent reports for evaluation, quantification, and adjustment purposes.
5. Report, during which the (Friend) Target Position Report, Error Likelihood Ellipsoid/Ellipse, and supporting information are made available on output channels from each TDU to all other TDU's, and during which any required auxiliary communications within the TDU set are completed. If a TPR/ELE combination is not available from a TDU at the end of the Process phase (for whatever reason, e.g., invalid data was detected, the Process phase ended before calculations could be completed), then an error code is sent to the other TDU's in place of the TPR/ELE, and this condition is signaled and detailed (as needed) as part of the other supporting data. See also the next section for how foe targets are processed.
6. Sync, during which no processing activity is scheduled. This is useful when coordinated processing activities require synchronized signal periods, i.e., one signal period begins when the previous one ends. The sync phase may be used to coordinate any overhead processing issues to implement this requirement.

It is assumed that a Foe Target X does not signal its position nor identification while operating in the frame of reference. Therefore, each TDU uses the Receive from All TDU, Query, and Confirm time phases to detect the spherical (a) range (ω), (b) elevation (φ), and (c) azimuth (θ) of a return of energy from irregularly timed isotropic radar pulses from each TDU. Note the spherical coordinates received from the radar receiver are relative to each TDU, so that each TDU translates the spherical coordinates into the static (standard) Euclidean dimension coordinates defined by the frame of reference before that information is communicated to the other TDU's. In this respect, the Spherical-to-Standard-Euclidean conversion is distributed across all theater TDU's, rather than having that functionality concentrated in a single TDU (or elsewhere)—this addresses the Issue of Redundant Distributed Processing.

The Error Likelihood Ellipsoid (ELE) is the 3-dimensional ellipsoidal subspace of the frame of reference that quantifies the likelihood of the reported target position being its actual position in the frame of reference. The ellipsoid becomes an ellipse when the frame of reference is 2-dimensional. A programmable set of discrete probability levels is marked on the ELE to present the various levels of certainty that are available for the TPR.

A TPR is said to have a given Level of Accuracy (expressed as a percentage between 0 and 100) if the calculated position of a (friend or foe) target is inside its ELE probability level for the same data as was used to calculate the TPR. This level of accuracy most likely changes as one group of TDU's data are used versus a different group of TDU's (even for the same target), as the most-recent previous data are used to quantify the variability of the TPR before new data are received at each TDU, or different combinations of TDU's data are used during the next Process phase.

Any calculation algorithm used to produce a set of numerical values intermediate and inferior to the TPR is called an Analytical Step. An analytical step is called a Mitigation if it is completed before the arrival time data {t₁, t₂, . . . , tₖ, . . . } are collected. An analytical step is called an Optimization if it occurs after the arrival time data {t₁, t₂, . . . , tₖ, . . . } are collected. The purpose of mitigation steps is to reduce the target position reports error variance σ2 across all TDU's. The purpose of optimization steps is to increase the likelihood of a higher-accurate TPR at a given probability level. An irregularly occurring, non-analytical step taken at any time to accomplish the same goals as mitigation and optimization is called Ad-Hoc. The collection of ad-hoc, mitigation, or optimization steps taken in an embodiment of the present invention is called its Containment Policies and referred to individually as a containment policy. These are stored and utilized in the Algorithm and Procedures section of each TDU (see FIG. 1).

The present invention Demerit System is an ad-hoc containment policy that acts simultaneously as mitigation and optimization. Under this system, the four TDU's chosen to calculate a TPR are those four that are (evidently) most likely to produce the “best” TPR based on past performance (thereby making it an optimization step), by way of reducing the variability of the utilized data (thereby making it a mitigation step).

Suppose there are n-many TDU's; however, only k≤n-many receive a signal from a target within the Receive window. There are (ⁿₖ)-many combinations of such TDU's taken k at a time, and (^{k}₄)-many combinations of the k-many that receive the signal taken four at a time. Each TDU has three values associated with it at the beginning of each processing cycle, namely its non-negative integer Demerit Count, its positive integer History Total, and its possibly null Boolean Confirmation Value. At the beginning of all processing, the demerit count for each TDU will be 0, the history total will be 1, and the confirmation value will be NULL. The confirmation value at the beginning of the processing cycle is determined by its observed value during the Confirm window. At the end of a processing cycle, the demerit count and history total are determined by the steps below, and the confirmation value is set back to null.

For each processing cycle, and for each of the (^{k}₄)-many combinations, the following steps determine the end-of-processing-cycle demerit counts and history totals.
1. Set the likelihood value λ (this is programmable).
2. Eliminate those τ0-many combinations that are coplanar.
3. Eliminate those τ1-many combinations that do not all have positive history totals and TRUE confirmation values.
4. The TDU's involved in the (τ0+τ1)-many combinations eliminated in Steps 2-3 are called Deficient for the current processing cycle. This designation is removed at the beginning of a new processing cycle.
5. Among the remaining, i.e., Qualifying Combinations, choose the combination of four TDU that collectively have the minimal sum of demerits; there will be at most ((^{k}₄)−(τ0+τ1))-many of these.
6. In case of a tie in Step 4, use the combination with the largest historical sum. In case of a further tie, choose the combination with the smallest individual demerit count. In case of a last tie, randomly choose uniformly among the finalists.
7. The combination so chosen is called the Calculating Combination, and the TDU's involved are called the Elected TDU's. Increment the history total by 1 for each elected TDU.
8. Subtract two demerits from the count for each elected TDU. Recall the demerit count for a TDU cannot become negative.
9. Calculate the TPR using the calculating combination of elected TDU.
10. Calculate the λ-ELE for the calculating combination of elected TDU.
11. Calculate the (^{k}₄)−(τ0+τ1)−1)-many TPR for all other qualifying combinations. Each of these TPR is called an Alternate Position Report (APR). Note that if τ0+τ1=(^{k}₄), then no TPR nor ELE may be calculated for that target during the current processing cycle—in this case, the TPR, ELE, and APR are all reported as NAN. If τ0+τ1=(^{k}₄)−1, then one TPR/ELE may be calculated for that target during the current processing cycle, yet the APR cannot be calculated—in which case, the APR is reported as NAN.
12. For each APR calculated in Step 11, if the APR falls outside the λ-ELE, then add one demerit to the count for each TDU involved in the APR.
13. For each APR calculated in Step 11, if the APR falls inside or on the λ-ELE, then subtract one demerit to the count for each TDU involved in the APR. Recall the demerit count for an TDU cannot become negative.
14. Add one demerit for each TDU that does not report a TRUE confirmation value.
15. When the demerit count for an TDU exceeds the Warning Threshold, send an Alert—part of the supporting information provided to the TDU set during the Report phase—to report a Frequently Deficient TDU.
16. When the demerit count for an TDU exceeds the Terminal Threshold, communication with the TDU is shut down, i.e., it no longer sends any information to the other TDU's, nor is sent any results from the other TDU's, and that TDU is not considered further for calculating a TPR, ELE, or APR (by setting its history total to 0) until explicitly reset (by an event trigger configurable to the present invention embodiment). Also send an alert to report a failed TDU when the TDU fails to send a TRUE confirmation value a configurable consecutive number of times. A failed TDU is treated (analytically) identically to a TDU that has exceeded the terminal threshold.
17. These steps are in addition to the disabling of a TDU for a TPR and ELE calculation cycle if proper query responses are not confirmed during the Receive window. The exact circumstances of this step are configurable to the present invention embodiment.
   A TPR in 3-dimensions is calculated for TDU I, II, III, and IIII as follows:
1. Choose three of the four TDU (say I, II, and III) and calculate the equation of the unique 2-dimensional plane containing these positions embedded in 3-dimensions.
2. Rotate the plane from Step 1 through a distance-preserving isomorphic transformation so that the z-component of all points on the plane from Step 1 are made 0 (this places all position solutions into a 2-dimensional standard Euclidean context). This is the action of Algorithm 1.
3. Calculate a Candidate Target Position Report (CTPR) based on the three transformed TDU positions. This is the action of Algorithm 3.
4. Rotate the transformed plane in 2-dimensions back to the original plane found in Step 1 (this is the inverse of Step 2—therefore it is also a distance-preserving isomorphic transformation between the two planes, in this case back into an embedded 2-dimension plane in 3-dimensions. The resulting point is called the Transformed Candidate Target Position Report (TCTPR). This is the action of Algorithm 2.
5. Repeat Steps 1 through 4 on a different combination of three of the four TDU (that has not yet been considered) until there are three such TCTPR.

Note that a present invention embodiment in 2-dimensions only uses Step 3. Each of the three TCTPR satisfies the distance and time requirements for the TDU's involved in the calculation. However, the (unique) TPR is the one point simultaneously satisfying the distance and time requirements for all TCTPR in the frame of reference.

The calculation to find that single point proceeds as follows: Let F:R³→R³ be the (real) 3-dimension to (real) 3-dimension multivariate function given by

$$\begin{matrix}F ( \begin{matrix}x \\ y \\ x\end{matrix} ) = ( {F}_{1} ( \begin{matrix}x \\ y \\ x\end{matrix} ) , {F}_{2} ( \begin{matrix}x \\ y \\ x\end{matrix} ) ) \\ = ( \begin{matrix}\sqrt{{( x - {x}_{1} )}^{2} + {( y - {y}_{1} )}^{2} + {( z - {z}_{1} )}^{2}} - \sqrt{{( x - {x}_{2} )}^{2} + {( y - {y}_{2} )}^{2} + {( z - {z}_{2} )}^{2}} - {f}_{1}^{C} \\ \sqrt{{( x - {x}_{1} )}^{2} + {( y - {y}_{1} )}^{2} + {( z - {z}_{1} )}^{2}} - \sqrt{{( x - {x}_{3} )}^{2} + {( y - {y}_{3} )}^{2} + {( z - {z}_{3} )}^{2}} - {f}_{2}^{C} \\ \sqrt{{( x - {x}_{2} )}^{2} + {( y - {y}_{2} )}^{2} + {( z - {z}_{2} )}^{2}} - \sqrt{{( x - {x}_{4} )}^{2} + {( y - {y}_{4} )}^{2} + {( z - {z}_{4} )}^{2}} - {f}_{3}^{C}\end{matrix} )\end{matrix}$$

which is the vector of differences between the Euclidean distances between (x, y, z) and four of the TDU positions (xₖ, yₖ, zₖ), for 1≤k≤4, at a particular moment in time, where (x, y, z) would be (x, y, 0) in the case of a 2-dimensional frame of reference, minus f; in each dimension representing the respective differences in times of signal detection at the TDU's taken two at a time (for example, with four TDU's, six differences in times of signal detection would be available, and three differences would be chosen for this calculation; in the formula given above, those three choices were (1,2), (1,3), and (2,4)). This means, for example, that f₁=t₁−t₂, since points (x₁, y₁, z₁) and (x₂, y₂, z₂) were involved in the first dimension of F. Furthermore, c is the (constant) rate of signal progress through the environment medium within the frame of reference. In the case where each TDU's communicates with the other TDU's through (targeted) electromagnetic energy, e.g., a radio frequency, then c would be the speed of light—other media examples include acoustic energy through water, visible light frequencies through salt fog, and percussive forces within blood vessels. However, to simplify calculations, c is usually set to 1 (regardless of actual speed) with an appropriate adjustment in the units used for distance—which must be used in all other measurements within this calculation. However, regardless of the particular value of c used in an embodiment of the current invention, it will always be assumed that all targets, friend or foe, move at a speed significantly slower than c, so that relativistic effects need not be considered in any target position calculation algorithm

The (unique) TPR is the value (x₀, y₀, z₀) where F(x₀, y₀, z₀)=0^{T}. This value is unique within the convex hull of the current positions of those TDU's involved in the calculation whenever the fⱼ values are meaningful.

Now let J be the Jacobian of F. We have

$$J = ( \begin{matrix}\frac{( x - {x}_{1} )}{( \sqrt{{( x - {x}_{1} )}^{2} + {( y - {y}_{1} )}^{2} + {( z - {z}_{1} )}^{2}} )} & \frac{( y - {y}_{1} )}{( \sqrt{{( x - {x}_{1} )}^{2} + {( y - {y}_{1} )}^{2} + {( z - {z}_{1} )}^{2}} )} & \frac{( z - {z}_{1} )}{( \sqrt{{( x - {x}_{1} )}^{2} + {( y - {y}_{1} )}^{2} + {( z - {z}_{1} )}^{2}} )} \\ \frac{x - {x}_{2}}{\sqrt{{( x - {x}_{2} )}^{2} + {( y - {y}_{2} )}^{2} + {( z - {z}_{2} )}^{2}}} & \frac{y - {y}_{2}}{\sqrt{{( x - {x}_{2} )}^{2} + {( y - {y}_{2} )}^{2} + {( z - {z}_{2} )}^{2}}} & \frac{z - {z}_{2}}{\sqrt{{( x - {x}_{2} )}^{2} + {( y - {y}_{2} )}^{2} + {( z - {z}_{2} )}^{2}}} \\ \frac{x - {x}_{1}}{\sqrt{{( x - {x}_{1} )}^{2} + {( y - {y}_{1} )}^{2} + {( z - {z}_{1} )}^{2}}} & \frac{y - {y}_{1}}{\sqrt{{( x - {x}_{1} )}^{2} + {( y - {y}_{1} )}^{2} + {( z - {z}_{1} )}^{2}}} & \frac{z - {z}_{1}}{\sqrt{{( x - {x}_{1} )}^{2} + {( y - {y}_{1} )}^{2} + {( z - {z}_{1} )}^{2}}} \\ \frac{x - {x}_{3}}{\sqrt{{( x - {x}_{3} )}^{2} + {( y - {y}_{3} )}^{2} + {( z - {z}_{2} )}^{2}}} & \frac{y - {y}_{3}}{\sqrt{{( x - {x}_{3} )}^{2} + {( y - {y}_{3} )}^{2} + {( z - {z}_{3} )}^{2}}} & \frac{z - {z}_{3}}{\sqrt{{( x - {x}_{3} )}^{2} + {( y - {y}_{3} )}^{2} + {( z - {z}_{3} )}^{2}}} \\ \frac{x - {x}_{2}}{\sqrt{{( x - {x}_{2} )}^{2} + {( y - {y}_{2} )}^{2} + {( z - {z}_{2} )}^{2}}} & \frac{y - {y}_{2}}{\sqrt{{( x - {x}_{2} )}^{2} + {( y - {y}_{2} )}^{2} + {( z - {z}_{2} )}^{2}}} & \frac{z - {z}_{2}}{\sqrt{{( x - {x}_{2} )}^{2} + {( y - {y}_{2} )}^{2} + {( z - {z}_{2} )}^{2}}} \\ \frac{x - {x}_{4}}{\sqrt{{( x - {x}_{4} )}^{2} + {( y - {y}_{4} )}^{2} + {( z - {z}_{4} )}^{2}}} & \frac{y - {y}_{4}}{\sqrt{{( x - {x}_{4} )}^{2} + {( y - {y}_{4} )}^{2} + {( z - {z}_{4} )}^{2}}} & \frac{z - {z}_{4}}{\sqrt{{( x - {x}_{2} )}^{2} + {( y - {y}_{4} )}^{2} + {( z - {z}_{4} )}^{2}}}\end{matrix} )$$

or expressed as

$$J = ( \begin{matrix}{j}_{11} & {j}_{12} & {j}_{13} \\ {j}_{21} & {j}_{22} & {j}_{23} \\ {j}_{31} & {j}_{32} & {j}_{33}\end{matrix} )$$

so that

$${J}^{- 1} = {( \begin{matrix}{j}_{11} & {j}_{12} & {j}_{13} \\ {j}_{21} & {j}_{22} & {j}_{23} \\ {j}_{31} & {j}_{32} & {j}_{33}\end{matrix} )}^{- 1} = \frac{1}{\vert J \vert} ( \begin{matrix}{j}_{22} {j}_{33} - {j}_{23} {j}_{32} & {j}_{13} {j}_{32} - {j}_{12} {j}_{33} & {j}_{12} {j}_{23} - {j}_{23} {j}_{32} \\ {j}_{31} {j}_{23} - {j}_{21} {j}_{33} & {j}_{11} {j}_{33} - {j}_{13} {j}_{31} & {j}_{21} {j}_{13} - {j}_{11} {j}_{23} \\ {j}_{21} {j}_{32} - {j}_{22} {j}_{31} & {j}_{12} {j}_{31} - {j}_{11} {j}_{32} & {j}_{11} {j}_{22} - {j}_{12} {j}_{21}\end{matrix} )$$

where

$$\vert J \vert = {j}_{11} {j}_{22} {j}_{33} - {j}_{11} {j}_{23} {j}_{32} - {j}_{12} {j}_{21} {j}_{33} + {j}_{12} + {j}_{31} + {j}_{23} + {j}_{21} {j}_{13} {j}_{32} - {j}_{13} {j}_{22} {j}_{31}$$

Applying the multivariate version of the Newton-Raphson Iterative Solution Method starting at the average of the candidate positions leads to the eventual TPR solution. It is theoretically possible to start at any “nearby” point to the eventual TPR solution and achieve adequate convergence within an acceptable number of iterations—each of the TDU positions (xₖ, yₖ, zₖ), for 1≤k≤4, would qualify in this respect. However, to take advantage of the availability of three such starting points that, in general, should surround the eventual TPR solution, i.e., be within the convex hull of the TDU positions, it is reasonable to start at the average of the (xₖ, yₖ, zₖ), for 1≤k≤4.

Specifically, the iterative step is given by

$$\begin{matrix}{p}_{0} = \frac{1}{3} {\sum }_{k = 1}^{3} {( {x}_{k} , {y}_{k} , {z}_{k} )}^{T} , \\ {p}_{n + 1} = {p}_{0} - {J}^{- 1} F ( {p}_{n} )\end{matrix}$$

where the transpose is needed to match the form of J, and a (positive) Convergence Tolerance tol>0 is used with

$$0 < {min}_{n \geq 0} {max}_{1 \leq k \leq 3} \{ \vert {J}^{- 1} {F ( {p}_{n} )}_{k} \vert \} < tol \to ( {x}_{0} , {y}_{0} , {z}_{0} ) \approx {p}_{n}^{T}$$

as the Iterative Stopping Rule, where

$${lim}_{n \to ∞} {p}_{n}^{T} = ( {x}_{0} , {y}_{0} , {z}_{0} )$$

asymptotically as tol→0. Therefore, the iteration stops as soon as the absolute value of all components of J⁻¹F(pₙ) fall below a given tolerance level. Note that when the stopping rule first applies at value n, we have pₙ is the TPR, not Pₙ₊₁, i.e., even if pₙ₊₁ has a different value, the TPR has been found as soon as the required level of tolerance has been uniformly achieved; this means p₀ may be the TPR (without the need for any iterations) if

$${max}_{1 \leq k \leq 3} \{ \vert {J}^{- 1} {F ( {p}_{n} )}_{k} \vert \} < tol .$$

Finally, an individual target's ELE is calculated based on the collection of TPR for that target that would have been calculated had each of the arrival times of that target—at the TDU's involved in the TPR calculation—were subject to random noise that follows a normal (Gaussian) probability distribution function with mean 0 and standard deviation σ>0. The more data, i.e., the more frequently TPR's have been calculated for a given target, upon which the ELE calculations may rely for its analytical methods, e.g., use a sequential Bayesian maximum likelihood estimator for σ, then the smaller (in area/volume) the ELE would be for a given level of likelihood.

In use, the present invention provides real-time complete surveillance of a theater of operations for any collection of friend/foe targets, wherein the surveillance system embodied in the present invention would quantify the uncertainty in an accurate and precise manner for improved decision-making support. The present invention provides a robust system that cannot be defeated by the elimination of one or many of the mobile sensors; the remaining ones provide the same level of analytical performed as provided with the full set of sensors. The theater of operations may be as grand as the airspace surrounding aircraft warfare, to as medium scale as tracking the movement of delivery unmanned aerial vehicles (UAV) for a grocery store, to as small scale as the detection of nano-scale disease sensors in a human's bloodstream. Moreover, the position reports and error likelihood ellipses/ellipsoids are the “products” produced by the invention.

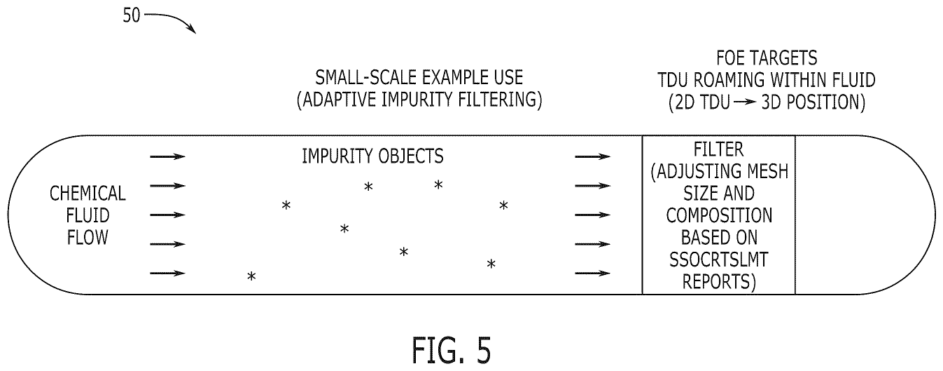

Note that the scale of the frame of reference is unrestricted. From large-scale operations, such as those involved in aviation, to medium-scale operations, such as with just-in-time manufacturing, to small-scale—even micro-scale-operations, such as a filtration system in a chemical processing context, see FIG. 5. To make this flexibility clear, consider the following three applications of the present invention methodology:

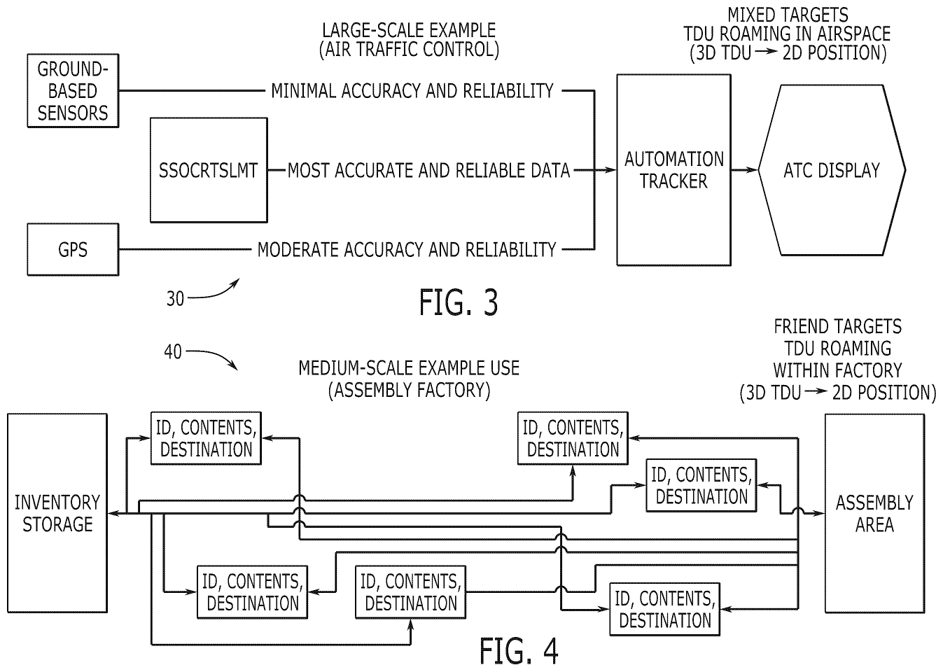

Referring to FIG. 3, a “Large-Scale Operations” may include low probability of detection, which is a common problem with ground-based radar systems trying to assess the position, velocity, and path of aircraft within its range of detection. The air-craft (“targets”) are often hundreds of thousands of meters away from the radar sensors, and the return of energy (required for primary radars) and electromagnetic signal detection (required for secondary radars) is always adversely affected by terrain variances, construction apparatus, and atmospheric conditions—even to the point where ground-based radars have “blind areas” where no usable information may be obtained no matter how much power the radar antenna may produce.

However, the present invention provides a solution for low-to-zero probability of detection scenarios. Since the TDU are mobile, they may be positioned much closer to the friend targets (that are trying to be detected), or in a vicinity that prior knowledge-based expert opinion makes highly likely to detect foe targets. This drastic reduction in distance from sensor to targets is reflected in a drastic improvement in the probability of detection, which is the most important aspect for a tracking system to report accurate and timely position/track information. Furthermore, in the presence of a sufficient number of TDU, a particularly important foe target may be even more closely tracked by having a subset of the TDU's follow the foe target as it maneuvers in the frame of reference, providing an unparalleled capability to always know the position of such a potentially dangerous target.

Referring to FIG. 4, a “Medium-Scale Operations”, the success of just-in-time manufacturing completely relies on the piece-parts of an assembly to be available on-hand at the point of assembly exactly when needed—but no sooner (to eliminate the chance of damage, misplacement, or misuse of the piece-parts before they are used). A central storage facility, populated by an incoming inspection process from multiple supplier chains, is commonly used to ensure the availability of the material, yet the “choosing material from stock,” “accounting for, and reacting to, inventory reductions,” and “transporting the material to the point of assembly exactly when it is needed” is commonly done manually, involving multiple resources (including human) that could be put to better, i.e., more productive, use.

The present invention provides a solution to the poor use of resources in just-in-time assembly: The TDU may act in all three capacities for bringing piece-parts from a central storage facility to the point of assembly.
(1) When a “call for service” is made to provide Part A to Assembly Area Z, a TDU may quickly arrive at the central storage facility (since TDU may move in three dimensions), and
(2) Either interact with a part selection device or otherwise obtain Part A (in whatever quantity is needed according to the call for service), and then
(3) Quickly transports Part A (in quantity) to Assembly Area Z (again moving in three dimensions), where, upon arrival, the TDU places the material in the designated place and position as described in the call for service.

During (c), the TDU communicates with a central inventory management system that accounts for the reduction of stock, thereby triggering, if needed, a purchase order for more Part A's from the designated supplier. The TDU then becomes available again for additional calls for service.

Finally, since multiple TDU's may be used within the same facility (and for other purposes as described herein), and the TDU's always communicate with each other within the frame of reference, e.g., the assembly factory building, there is no possibility of collision among the multiple TDU's that may be simultaneously providing just-in-time manufacturing or other mission-critical services.

In a “Small-Scale Operation” a TDU may be of any size, including microscopic, according to the materials and technology used to build the TDU's. Microscopic TDU's could be used to detect disease in living tissue, find impurities to be removed from medications even at the molecular level, and provide experimental data at a scale and level of precision and detail that will be absolutely required for foundational artificial intelligence technology to become truly useful. Furthermore, the use of microscopic TDU's means there may be thousands, millions, perhaps even trillions of them in use at the same time when the scale of operations focuses on ultra-small friend and foe targets within a relatively large frame of reference. An example of this could be the surveillance of radioactivity within a nuclear reactor, where there are only foe targets (radioactive particles), and the measure of their type, place, velocity, and density count within the coolant containment system are primary measures of safe reactor operation.

These examples of the present invention use only demonstrate a few embodiments, and the full extent of the present invention applicability is the potentially unlimited in the ways in which the system provides a level of context information, e.g., count and position data, far beyond the level of precision, accuracy, and reliability that any other such system in the prior art may provide.

The present invention embodies software/hardware for making analytical calculations, as well as the manufacture of breakthrough-technology in the mobile sensors and the Command, Control, and Communications (C3) capabilities. The embodied software/hardware faster processing, higher precision and accuracy standards, and the adoption of APNAC/RAC™ technology for providing faster/more accurate results. (APNAC/RAC™ is a trademark of PQI Consulting LLC.) Logic provided in software/hardware by PQICSTAT™ library of analytical modules in high-low- and machine-level implementations. The systemic components both enable an improvement in the functioning of the computer and an improvement in the technology of surveillance through improving signal processing analysis. (PQICSTAT™ is a trademark of PQI Consulting LLC.) Any re-arrangement of the components/elements of the invention as documented herein may result in a non-functional system, i.e., it may fail to operate at all; it may output nothing, let alone something of value.

In embodiments requiring a network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, Mac-OS, Windows, Unix, OpenVMS, an operating system based on Linux, or any other appropriate operating system, including future operating systems. In some embodiments, the computing systems may be a web server running web server applications such as Apache, Microsoft's Internet Information Server™, and the like.

In particular embodiments, the computing systems include a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example, and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface may include hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface.

The communication interface includes hardware, software, or both providing one or more interfaces for communication (e.g., packet-based communication) between the computing systems over the network. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the invention and that modifications may be made without departing from the spirit and scope of the invention as set forth in the following claims.

What is claimed is:

1. A system for simultaneously determining locations of a plurality of targets in a 3-dimensional frame of reference (3DFOR), the system comprising:
a plurality of theater detection units (TDUs), each configured to send a set of timing data, wherein each theater detection unit has a central processing unit configured to (a) transmit and receive electromagnetic energy from each target of the plurality of targets, (b) determine an arrival time for each transmitted and received electromagnetic energy, (c) generate a target position report when the set of timing data is sent to the central processing unit, wherein the target position report (TPR) defines a location for each target of the plurality of targets, and (c) generate an elliptical/ellipsoidal probability map for each said location; and
each central processing unit configured to determine a level of accuracy for each target position report based on a comparison of its location against the location of the elliptical/ellipsoidal probability map, whereby the central processing unit optimizes each subsequent TPR based on the level of accuracy of a previous target position report of that central processing unit,
wherein each central processing unit is identical regarding generation of the target report and the elliptical/ellipsoidal probability map.

2. The system of claim 1, wherein each TPR defines each target of the plurality of targets as a foe target or a friend target based on signal detection of each target.

3. The system of claim 2, wherein the arrival time of each target is based on an absolute timing schedule.

4. The system of claim 3, wherein the absolute timing schedule is defined by a Network Time Protocol synchronization.

5. The system of claim 4, wherein said location is a position along the 3DFOR.

6. The system of claim 5, wherein a transformed target position report (TTPR) comprises positions along the TPR wherein each position is subject to a distance-preserving isomorphic transformation.

7. The system of claim 6, wherein each TDU moves within the 3DFOR along a known path.

8. The system of claim 7, wherein the known path is known only to the TDU associated thereto.
